(19) United States
(12) Patent Application Publication
(10) Pub. No.: US 2005/0051284 A1
(43) Pub. Date: Mar. 10, 2005

(54) Device for arching out a roller sun vizor awning

(76) Inventor: Klaus Fischer, Schopfloch (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/486,008

(22) PCT Filed: Jun. 19, 2002
(86) PCT No.: PCT/EP02/06794

(30) Foreign Application Priority Data
Aug. 6, 2001 (DE) 101 37 807.6

(51) Int. Cl. B60J 1/20

(52) U.S. Cl. 160/370.22

(57) ABSTRACT

A roller-blind arrangement has an unrollable roller blind which is moveable on a guide device, a roller-blind shaft arranged under a covering and a slotted opening located in the covering. The arrangement also has a mimic for arching out the roller blind, with the mimic being adjustable into an active position and by way of which a corresponding part acts directly on the roller blind.

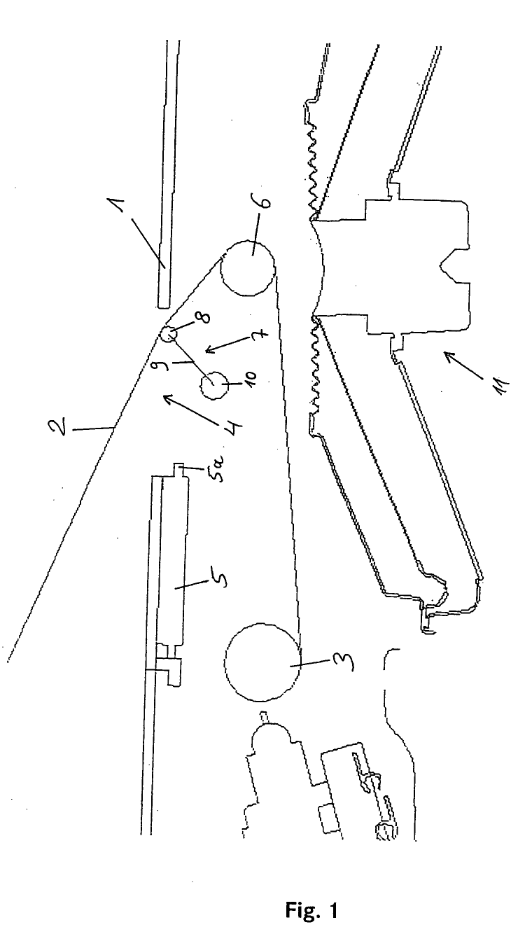

This application claims the priority of 131 37 807.6, filed Aug. 6, 2001, and PCT/EP02/06794, filed Jun. 19, 2002, the disclosures of which are expressly incorporated by reference herein.

### BACKGROUND OF THE INVENTION

The present invention relates to a roller-blind arrangement having an unrollable roller blind which is moveable on a guide device, a roller-blind shaft arranged under a covering and having a slotted opening located in the covering. The arrangement also has a device for arching out the roller blind.

A roller-blind arrangement of this type is suitable, for example, for covering a rear window of a motor vehicle against the incidence of light or as a way of protecting against looking in. In this case, a linear slot through which the roller blind is guided via a deflection mechanism is provided in the rear parcel shelf.

If a window is arched, the distance between the window and the roller-blind outlet at the linear slotted opening changes with the profile of the arching of the window. This gives rise to dead spaces and also to visual impairments which are undesirable, for example, in a superior class of vehicle.

DE 19803129 A1 shows, for a motor vehicle, a slotted opening in the rear parcel shelf. The opening has a profile which follows the arching of the window. One of the edges of the slotted opening is designed as a guide edge over which the roller blind is guided and by means of which it is arched in the direction of the window. A disadvantage of this design is the load to which the roller blind is subjected. Since the roller blind is under tensile stress, it is pressed with the corresponding force against the guide edge. This leads to considerable friction during its extension and retraction, and consequently to the blind and its coating being subject to an abrasive load. This causes problems in long-term operation and, moreover, the appearance of the blind also suffers.

### SUMMARY OF THE INVENTION

An object of the present invention is to enable a roller blind to arch out with the above-mentioned disadvantages being avoided.

To achieve this object, the device for arching out the roller blind is a “mimic” which can be adjusted into an active position. The ability of the mimic which arches out the roller blind to be adjusted between an active and an inactive position enables this mimic to act on the roller blind only when required instead of permanently.

In an advantageous embodiment, the mimic can be actuated independently of the movement of the roller blind, thus avoiding the movement of the roller blind during its retraction or extension being coupled to the actuation of the mimic for arching the roller blind. In this case, the mimic is advantageously arranged below the covering in order to be able to ensure an arrangement which is protected from external influences and is largely invisible.

The adjustable mimic can be configured as a pivoting lever which can be pivoted in a simple manner between an active position acting on the roller blind and an inactive position. In an alternative embodiment, the adjustable mimic is a slide arranged parallel to the covering and adjustable along the latter. The slide can act, on one hand, on the roller blind and can be used, on the other hand, to cover the slotted opening.

In one expedient configuration, the adjustable mimic has an arched mechanism directly on the roller blind, which mechanism can be used to bring about a predetermined arching of the roller blind, at least in a subregion thereof.

In the case of the two alterative embodiments with a pivoting lever or a slide, it is furthermore expedient to provide a deflector for the roller blind on the adjustable mimic in order to be able to extend and retract the roller blind even in the arched state under the action of the mimic without a relatively large stress being exerted on the material. In one advantageous development, the deflector is a roller.

The adjustable mimic can be arranged in the region of the slotted opening. The necessary structural space is available in this region, and the roller blind can be arched out in a largely imperceptible manner.

### BRIEF DESCRIPTION OF THE DRAWINGS

Other objects, advantages and novel features of the present invention will become apparent from the following detailed description of the invention when considered in conjunction with the accompanying drawings.

The sole FIGURE is a schematic cross-sectional view of covering with roller blend arrangement according to the present invention.

### DETAILED DESCRIPTION OF THE DRAWINGS

The sole FIGURE shows a covering, with a roller-blind arrangement in cross section, the covering which is shown being a rear parcel shelf of a passenger vehicle. The covering or rear parcel shelf 1 is arranged in the region of a rear window (not shown). In order to limit the incidence of light through this rear window or in order to prevent someone looking through the rear window into the interior of the passenger vehicle, a roller blind 2 with which large sections of the rear window can be covered is provided. In this case, the roller blind is arranged largely parallel to the extent of the rear window. However, the roller blind 2 is only moved in front of the rear window when required. If a covering is not required, the roller blind 2 is wound up on a roller-blind shaft 3 located under the rear parcel shelf. The extension of the roller-blind shaft takes place in a conventional manner via a pulling device (not shown) which is arranged displaceably on a guide, which is fixed on the vehicle, and under the effect of which pulling device the roller blind 2, when being extended, is unwound from the roller-blind shaft.

When the roller blind 2 is extended into the position in front of the rear window, the roller blind 2 is guided through a slotted opening 4 in the rear parcel shelf 1. The slotted opening 4 extends at least over the width of the roller blind. This slotted opening 4 is normally closed solely for visual reasons, in particular in the superior class of vehicles, and is only opened when required. In the illustrated embodiment, the slotted opening 4 is normally completely closed by a slide 5 which is displaced, before the roller blind 2 is extended, parallel to the rear parcel shelf 1 into a position on the underside of the rear parcel shelf, in which the slotted opening 4 is then opened.

Furthermore, the roller-blind arrangement has a deflecting roller 6 via which the roller blind 2 can be moved into the position largely parallel to the rear window. The roller blind 2 has to be guided via the deflection roller 6, since there is not sufficient space below the rear parcel shelf 1 in the region of the slotted opening 4, also because of the provision of a speaker box 11, for the roller-blind shaft 3 and the corresponding mechanism for unrolling and rolling up the roller blind 2.

For visual reasons and also in order to avoid unnecessary dead spaces, it is endeavored, as far as possible over the entire surface, to arrange the roller blind 2, when extended, equidistantly from the rear window. However, a rear window of a passenger vehicle is generally arched outward in the transverse direction. In order to be able to approximate the shape of the roller blind 2 to this arching, the roller blind 2 is also arched outward by a corresponding mimic 7 in the region of the slotted opening 4. In this case, the mimic 7 has a cylindrical rod 8 which acts directly on the roller blind 2 with a compressive force and extends in the transverse direction, i.e. perpendicular with respect to the direction of movement of the roller blind 2.

The rod 8 in turn is articulated via a lever 9 on a joint 10 fixed on the vehicle and can be pivoted about the joint 10 on a circular path. If the roller blind 2 is not in use, the rod 8 is also in an inactive position in which, for example, the lever 9 extends parallel to the rear parcel shelf 1. It is only in this situation that the rod 8 is brought into contact with the extended roller blind 2, i.e. the roller blind 2 is not pulled over the rod 8 as it is being extended through the slotted opening 4, but rather is arched only after it has been extended, by the pivoting of the mimic 7 and the resultant action of the rod.

Depending on the extent of the desired arching of the roller blind 2, the cylindrical rod 8 can be configured to extend to a greater or lesser extent in the transverse direction. The cylindrical rod 8 can also, for its part, have an arching which is then brought about on the roller blind by direct action on the latter. It is furthermore also within the scope of the invention to use a ball or the like instead of a rod.

The shape of the roller blind is ensured by the fact that the roller blind is tensioned by the pulling device, which acts on the roller-blind shaft 3 counter to a pull-back spring and is intended for extending the roller blind, and is correspondingly arched via the rod 8 or another adequate device.

In a departure from the illustrated embodiment, the slide 5 may also serve as the mimic for arching the roller blind 2 by it being moved back again, after extension of the roller blind, into the region of the slotted opening 4 until its end side 5a, which is appropriately designed, enters into contact with the roller blind and the desired arching is thereby obtained. This also has the secondary effect of being able to minimize the size of the slot.

However, the last-mentioned effect can also be used, when a pivoting lever is provided as the mimic for arching out the roller blind, by the slide 5 being moved, after the roller blind 2 is extended and arched out, within the possible frame and back in the direction of the roller blind 2, with closing of the slotted opening, without, however, the roller blind being arched out by the slide.

It is likewise possible to extend and retract the roller blind 2 even if the mimic for arching the roller blind is active if, in order to avoid an excessive mechanical stress of the roller blind, that portion of the mimic which is in direct contact with the roller blind is a roller on which the roller blind 2 can roll with a correspondingly low amount of friction as it is being retracted and extended.

1-9. canceled.

10. A roller-blind arrangement, comprising an unrollable roller blind which is moveable on a guide device, a roller-blind shaft arranged below a covering having a slotted opening, and a mimic for arching out the roller blind, arranged to be adjusted into an active position.

11. The arrangement as claimed in claim 10, wherein the mimic is arranged to be actuatable independently of movement of the roller blind.

12. The arrangement as claimed in claim 10, characterized in that the mimic is arranged below the covering.

13. The arrangement as claimed in claim 12, wherein the mimic is arranged to be actuatable independently of movement of the roller blind.

14. The arrangement as claimed in claim 10, wherein the adjustable mimic is a pivoting lever.

15. The arrangement as claimed in claim 10, wherein the adjustable mimic is a slide which is arranged parallel to and adjustable along the covering.

16. The arrangement as claimed in claim 10, wherein the mimic is a curved device acting directly on the roller blind.

17. The arrangement as claimed in claim 11, wherein the mimic has a deflector.

18. The arrangement as claimed in claim 17, wherein the deflector is a roller.

19. The arrangement as claimed in claim 10, wherein the mimic is arranged in the region of the slotted opening.

20. A method for selectively covering an area of a vehicle comprising unrolling a roller blind movable on a guide device through an opening in a cover, and activating a mimic to arch out the roller blend so as to conform to a profile of the covered area.
